(19) United States
(12) Patent Application Publication
(10) Pub. No.: US 2013/0112604 A1
(43) Pub. Date: May 9, 2013

(54) Valve For High Pressure Analytical System

(71) Applicants: Russell L. Keene, Sudbury, MA (US); Marc Lemelin, Douglas, MA (US)

(72) Inventors: Russell L. Keene, Sudbury, MA (US); Marc Lemelin, Douglas, MA (US)

(73) Assignee: WATERS TECHNOLOGIES CORPORATION, Milford, MA (US)

(21) Appl. No.: 13/695,823

(22) PCT Filed: Jun. 14, 2011
(86) PCT No.: PCT/US11/40258

§ 371 Date: Jan. 9, 2013

Related U.S. Application Data
(60) Provisional application No. 61/355,330, filed on Jun. 16, 2010.

(51) Int. Cl. F16K 3/08; B01D 15/08

(52) U.S. Cl. CPC F16K 3/08; B01D 15/08
USPC 210/198.2; 251/304

(57) ABSTRACT

A high pressure valve, comprising a stator having a stator sealing surface with at least one stator port and a rotor having a rotor sealing surface with at least one rotor port or channel. The rotor is movable with respect to the stator to selectively move the rotor port or channel into and/or out of alignment with the stator port thereby to open and/or close the valve. The stator port is provided by a passage with a first part that extends perpendicularly from the stator sealing surface and a second part that extends from the first part in a direction that is other than perpendicular from the stator sealing surface.

### CROSS-REFERENCE TO RELATED APPLICATIONS

This application claims benefit of U.S. Provisional Application No. 61/355,330 filed 16 Jun. 2010, the entire contents of which are expressly incorporated herein by reference.

### TECHNICAL FIELD

This invention relates generally to valves and more particularly to a valves for high pressure analytical systems, such as high pressure liquid chromatography systems.

### BACKGROUND

Many analytic systems incorporate valves for controlling fluid flow. An example is the use of shear valves in some chromatography systems. These valves often must retain fluid integrity, that is, such valves should not leak fluids. As a valve is cycled, however, between positions, the loads placed on the moving parts cause wear.

Some valves are subjected to high pressures. For example, sample injector valves in high performance liquid chromatography (HPLC) apparatus, are exposed to pressures approximately 1,000 to 5,000 pounds per square inch (psi), as produced by common solvent pumps. Higher pressure chromatography apparatus, such as ultra high performance liquid chromatography (UHPLC) apparatus, have solvent pumps that operate at pressures up to 15,000 psi or greater.

As the pressure of a system increases, wear and distortion of a valves components, such as a rotor and a stator, tends to increase, and the valve's expected lifetime may be reduced.

### SUMMARY

The invention arises, in part, from the realization that the operating life of a rotary shear valve may be extended by reducing the size of the valve stator's ports. Thus, for example, the invention is particularly well suited to provide improved rotary shear injection valves for delivery of samples in an HPLC or high-pressure apparatus.

A first aspect of the invention provides a valve, e.g. a high pressure valve, comprising a stator having a stator sealing surface with at least one stator port and a rotor having a rotor sealing surface with at least one rotor port or channel, the rotor being movable with respect to the stator to selectively move the rotor port or channel into and/or out of alignment with the stator port thereby to open and/or close the valve, wherein the stator port is provided by a passage with a first part that extends perpendicularly from the stator sealing surface and a second part that extends from the first part in a direction that is other than perpendicular from the stator sealing surface.

Preferably, the size or diameter or cross-section of the first passage part is equal to or less than that of the second passage part. More preferably, the size or diameter or cross-section of the first passage part is less, for example 10 to 90 percent or 20 to 80 percent, e.g. 30 to 70 percent, preferably 40 to 60 percent, more preferably 45 to 55 percent and most preferably about 50 percent, that of the second passage part. The passage or one or both passage parts may have a circular cross-section. For example, the diameter of the first passage part may be 0.15 mm or 0.006 or 0.0055 inches and/or the diameter of the second passage part may be 0.30 mm or 0.011 inches.

The second passage part preferably extends at an angle relative to the first part, for example an angle of between 1 and 90 degrees or between 1 and 70 or 80 degrees, e.g. between 1 and 60 degrees, preferably between 10 and 50 degrees, more preferably between 20 and 40 degrees and most preferably about 30 degrees.

The stator may comprise a projection, e.g. a circular or frustoconical projection, which may be circular and/or which may comprise or incorporate the stator sealing surface. The rotor may comprise a recess or depression which may cooperate with or correspond to the projection of the stator. The rotor is preferably rotatable relative to the stator to selectively move the rotor port or channel into and/or out of alignment with the stator port thereby to open and/or close the valve. The stator and/or rotor may include two or more ports or channels or passages.

The axis of the first passage part is preferably aligned with the axis of the second passage part, e.g. where the first and second passage parts meet or intersect or are joined. The valve or stator may further include a fitting or fitting bore, for example that is coupled or fluidly coupled to the passage, e.g. to the second passage part, and/or that is coaxial therewith.

A second aspect of the invention provides a stator for a valve as described above.

A third aspect of the invention provides a pressurized, e.g. a high pressure, fluid control system comprising a valve or stator defined in any one of the six preceding paragraphs.

A fourth aspect of the invention provides an analytic instrument or apparatus or machine or system, for example a chromatograph or chromatographic instrument or apparatus or machine or system such as a liquid chromatography instrument or apparatus or machine or system, the instrument or apparatus or machine or system comprising a valve or stator or pressurized fluid control system defined in the immediately preceding paragraph.

Other aspects, features, and advantages are in the description, drawings, and claims.

### BRIEF DESCRIPTION OF THE DRAWINGS

FIG. 1 is a plan view of the portion of a stator of a prior art high pressure valve showing the stator sealing surface;

FIG. 2 is a cross-sectional view through line A-A of FIG. 1;

FIG. 3 is an exploded perspective view of a rotary shear valve having a stator having stator ports of reduced size.

FIG. 4A is a plan view of the portion of a stator of the rotary shear valve of FIG. 3 showing the stator sealing surface. and

FIG. 4B is a cross-sectional view through line B-B of FIG. 4A.

FIGS. 5A and 5B are schematic views of a high performance liquid chromatography system including the rotary shear valve of FIG. 3.

Like reference numbers indicate like elements.

### DETAILED DESCRIPTION

High pressure valves that operate by selectively aligning ports or channels in a moving rotor with ports in a stator are subjected to aggressive cyclic loading. It has been observed by the applicants that stator seal surface port geometry and size has a major influence on valve lifetime. A smaller stator port appears to cause less distortion of the rotor surface as the rotor slides or rotates across the hole.

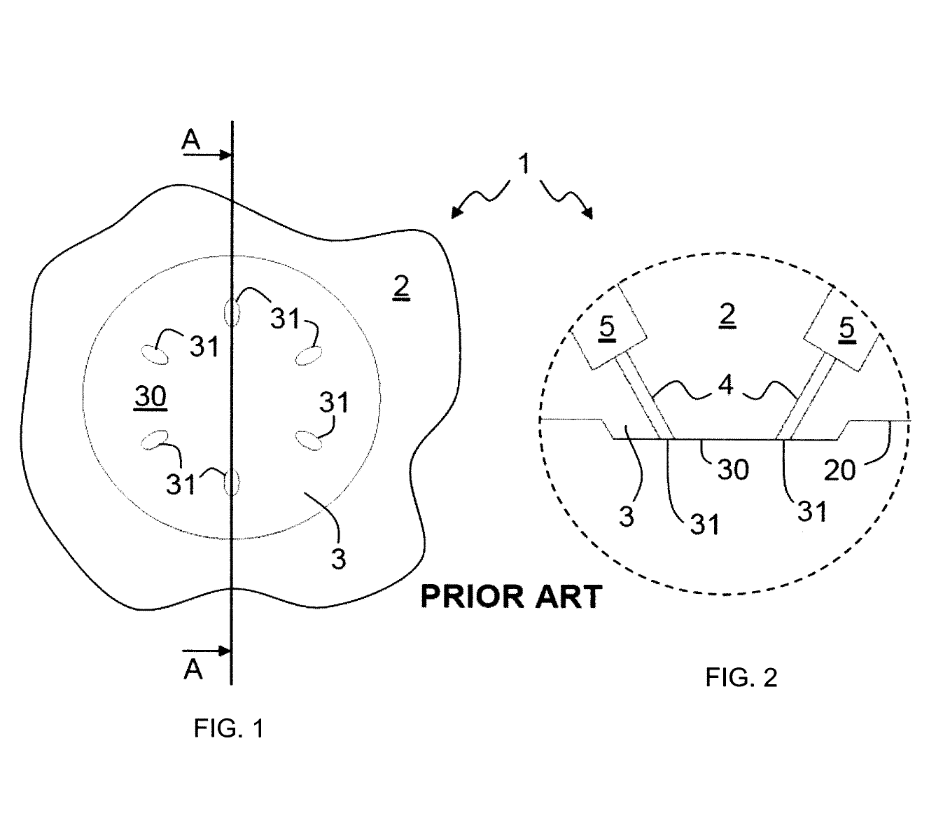

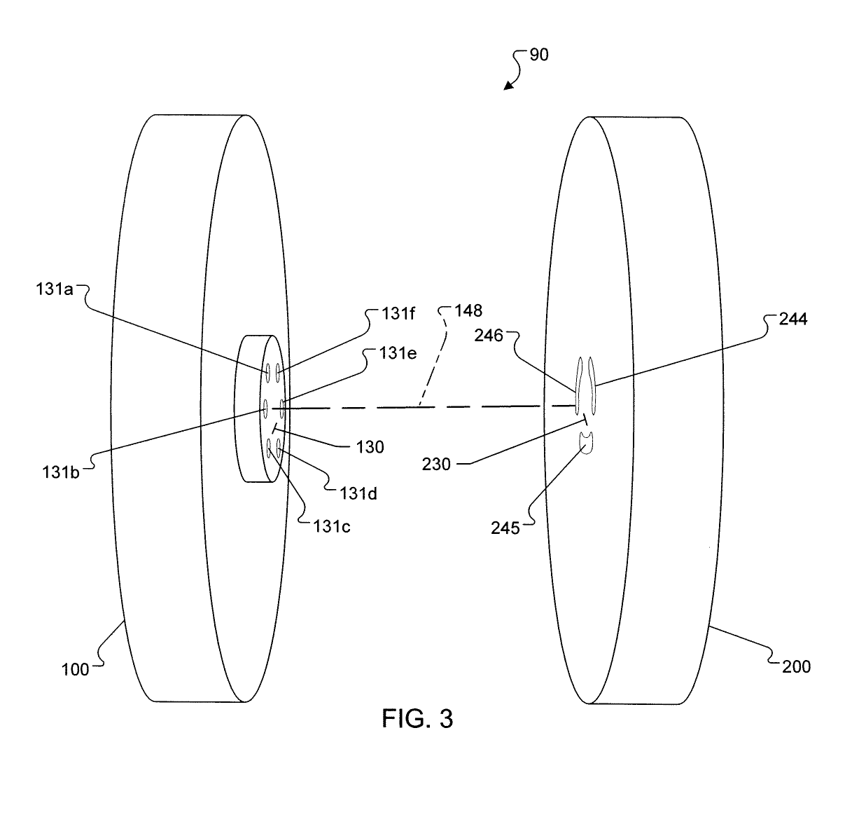

FIGS. 1 and 2 show the stator 1 of a known high pressure valve used in high precision applications. The stator 1 includes a body 2 with a frustoconical projection 3 providing a stator sealing surface 30 from which extend six passages 4 and first and second fitting bores 5.

The projection 3 extends from a face 20 of the body 2 and tapers from the body face 20 decreasing in diameter to the stator sealing surface 30. The stator sealing surface 30 is relatively small with a diameter of 4.826 mm (0.190 inches) and includes six ports 31.

Each passage 4 extends from one of the ports 31 at an angle of approximately 60 degrees relative to the stator stator sealing surface 30 and opens into a respective fitting bore 5. This is done so that standard sized fittings for connecting fluid supply and/or return (not shown) to or from the ports 31, wherein such fittings would be too large to fit side by side if the passages 4 were to extend perpendicularly from the stator sealing surface 30. The passages 4 have a diameter of approximately 0.2794 mm (0.011 inches) and a length of about 2.54 mm (0.1 inches).

In use, a rotor of the valve is rotatable with respect to the stator to selectively move one or more rotor ports or channels into and/or out of alignment with one or more or each of the stator ports thereby to open and/or close the valve. The applicants have observed two issues with this arrangement that limit the effective size of the ports 31.

First, the diameter of the passages 4 is limited by the requirements for practical drilling, which usually requires the drill diameter to be at least 0.1 times the drill depth. Thus, in order to reduce the diameter of the passages 4, their length would need to be decreased, moving the fitting bore 5 closer to the stator sealing surface 30. However, fittings must be spaced sufficiently from the stator sealing face 30 to prevent distortion that may be caused by pressure from the tube ends.

Second, the ports 31 in this arrangement are elliptical by virtue of the angle at which the passages 4 extend. This results in a higher effective port size, since the major axis of the ellipse is approximately 15 percent larger than the minor axis, and a generally less symmetrical arrangement leading to increased fatigue in the rotor surface.

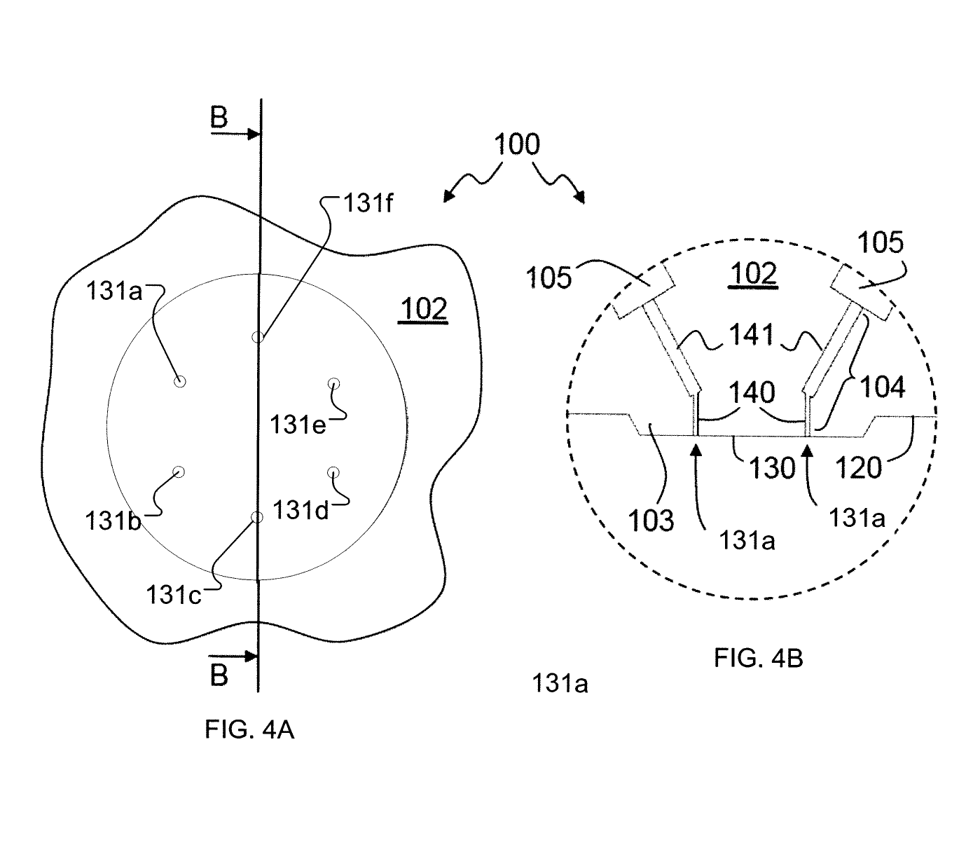

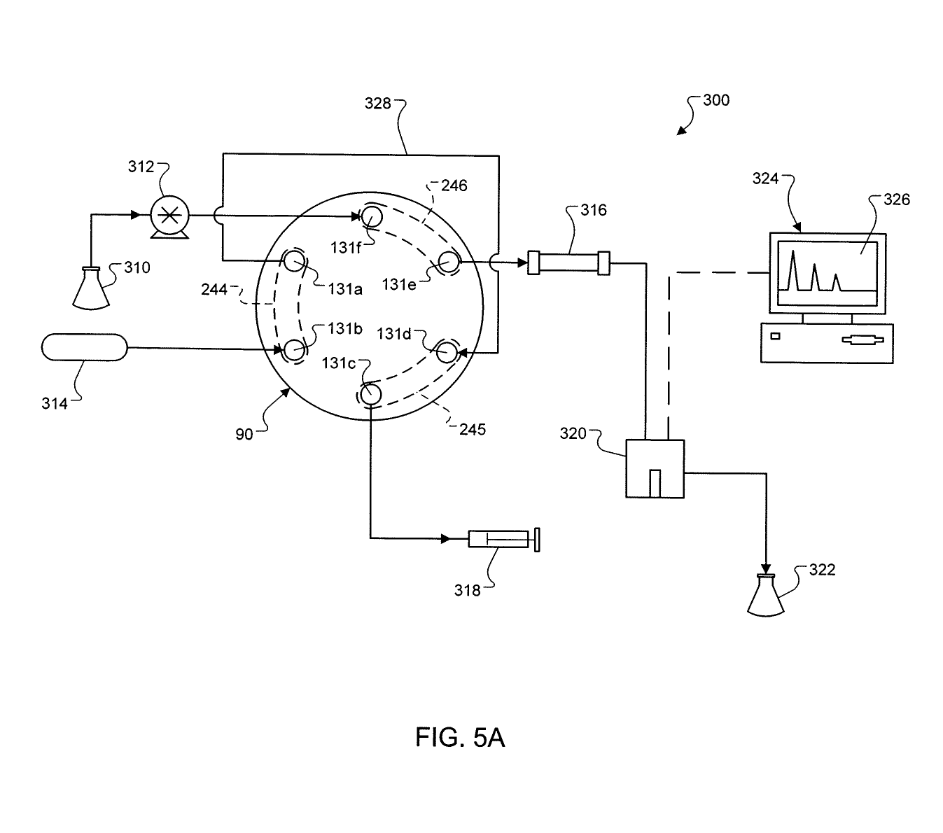

Referring to FIG. 3, there is shown a six-port rotary shear valve 90 for use in a high pressure liquid chromatographic system. The valve 90 includes a stator 100 and a rotor 200. As shown in FIGS. 4A and 4B, the stator 100 includes a body 102 with a projection 103, which is frustoconical in this embodiment providing a stator stator sealing surface 130 from which extend six passages 104 and first and second fitting bores 105.

The projection 103 extends from a face 120 of the body 102 and tapers from the body face 120 decreasing in diameter to the stator sealing surface 130. The stator sealing surface 130 has a diameter of 4.826 mm (0.190 inches) and includes six ports 131a-f in this embodiment.

Each passage 104 includes a first part 140 that extends perpendicularly from stator sealing surface 30 and a second part 141 that extends from the first part 140 at an angle of approximately 30 degrees relative thereto, or an angle of approximately 60 degrees relative to the stator sealing surface 130, and opens into a respective fitting bore 105.

In this embodiment, the first passage parts 140 have a diameter of approximately 0.1524 mm (0.006 inches) and a length of approximately 1.524 mm (0.06 inches), while the second passage parts 141 have a diameter of approximately 0.2794 mm (0.011 inches) and a length of about 2.54 mm (0.1 inches). The axis of the first passage part 140 is aligned with the axis of the second passage part 141 where the first and second passage parts 140, 141 meet. The stator 100 can be manufactured from stainless steel, or other corrosion resistant alloy. The stator sealing surface 130 can be coated with a wear resistant material, for example diamond-like carbon (DLC).

The use of a passage 104 formed in two parts 140, 141 provides a great deal of flexibility. For example, the ports 131a-f are no longer elliptical as with prior art designs and their diameter may be decreased significantly. This arrangement seems counterintuitive at first, since it adds some complications in the manufacturing process. However, the additional flexibility far outweighs such disadvantages, particularly for high pressure and high precision applications.

Referring again to FIG. 3, the rotor 200 has a rotor sealing surface 230, which includes three fluid conduits 244, 245, 246 in the form of arcuate channels, which link pairs of adjacent ports 131a-f. When assembled, the rotor sealing surface 230 is urged into contact with the stator interface stator sealing surface 130, e.g., by pressure exerted on the rotor 200 by a spring, to help ensure a fluid-tight seal therebetween. The rotor 200 is capable of rotation about an axis 148 and has two discrete positions relative to the stator 100. In a first position, channel 244 overlaps and connects ports 131a and 131b, channel 245 overlaps and connects ports 131c and 131d, and channel 246 overlaps and connects ports 131e and 131f. In the second position, channel 244 overlaps and connects ports 131b and 131c, channel 245 overlaps and connects ports 131d and 131e, and channel 246 overlaps and connects ports 131f and 131a.

The rotor 13 can be manufactured from polyether-ether-ketone, such as PEEK™ polymer (available from Victrex PLC, Lancashire, United Kingdom), filled with between 20 and 50% carbon fiber. Alternatively or additionally, the rotor 13 can be manufactured from polyimide (available as DuPont™ VESPEL® polyimide from E. I. du Pont de Nemours and Company), or polyphenylene sulfide (PPS).

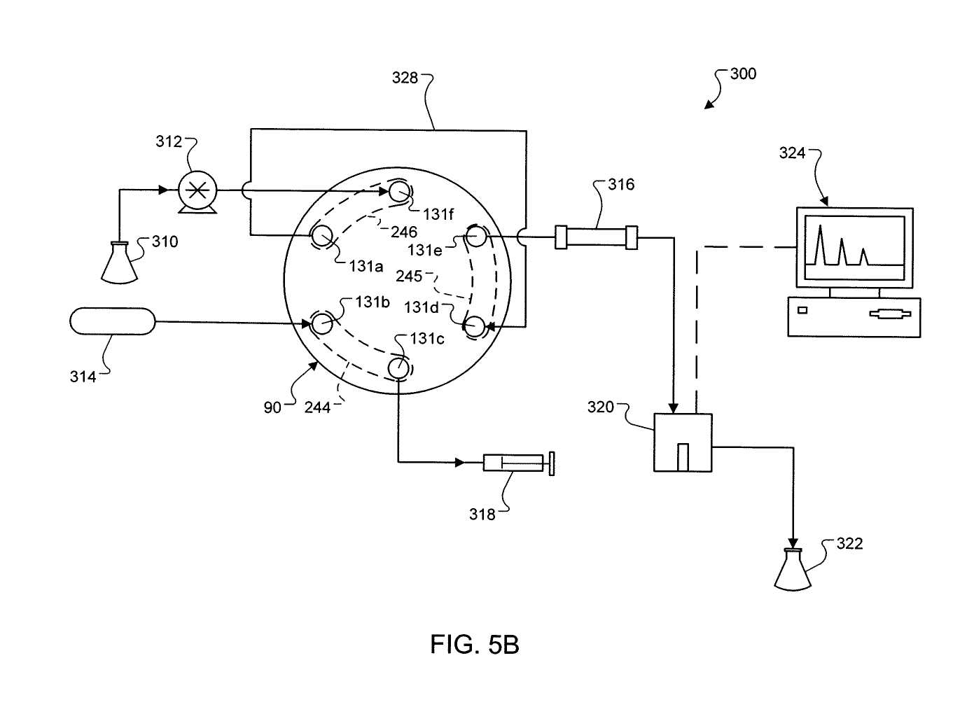

A valve with this configuration can be used for injecting samples into the flow of a fluid for subsequent chromatographic analysis. For example, FIGS. 5A and 5B illustrate a high pressure liquid chromatography (HPLC) system 300 that incorporates the six-port rotary shear valve 90 of FIG. 3. Referring to FIGS. 5A and 5B, a carrier fluid reservoir 310 holds a carrier fluid. A carrier fluid pump 312 is used to generate and meter a specified flow rate of the carrier fluid, typically milliliters per minute. The carrier fluid pump 312 delivers the carrier fluid to the valve 90. A sample, from a sample source 314 (e.g., a sample vial), is introduced into the valve 90 where it can combine with the flow of carrier fluid, which then carries the sample into a chromatography column 316. In this regard, the sample may be aspirated from the sample source 314 through the action of an aspirator 318 (e.g., a syringe assembly). A detector 320 is employed to detect separated compound bands as they elute from the chromatography column 316. The carrier fluid exits the detector 320 and can be sent to waste 322, or collected, as desired. The detector 320 is wired to a computer data station 324, which records an electrical signal that is used to generate a chromatogram on its display 326.

In use, when the valve 90 is in a first position (FIG. 5A), port 131a is in fluid communication with port 131b, port 131c is in fluid communication with port 131d, and port 131e is in fluid communication with port 131f. In this first position, the sample flows into the valve 90 via port 131b and then into a sample loop 328 (e.g., a hollow tube) via port 131a, and carrier fluid is delivered into the valve 100 via port 120 and then toward the chromatography column 316 and the detector 320 via port 131e.

When the valve's rotor is rotated into a second position (FIG. 5B), port 131a is placed in fluid communication with port 131f, port 131b is placed in fluid communication with port 131c, and port 131d is placed in fluid communication with port 131e. In this second position, the carrier fluid is conveyed through the sample loop 328, where it merges with the sample, and then carries the sample downstream to the chromatography column 316 and the detector 320.

For some liquid chromatography applications, the valve 30 may have to operate at under pressure conditions of above 10,000 pounds per square inch (psi). The mechanical wear and tear on the valve stator and rotor under these extreme pressure conditions can reduce the operating life of the valve. However, by reducing the size of the stator ports the operating life of the valve may be extended under these high pressure working conditions. In particular, a smaller stator port may cause less distortion of the rotor surface as the rotor slides or rotates across the hole. Rotor distortion causes fatigue in the material and this is exacerbated where a plastics material is used.

It will be appreciated by those skilled in the art that several variations are envisaged without departing from the scope of the invention. For example, the valve need not be a high pressure valve, although the invention is particularly useful in such a valve. The second passage part 141 may extend from the first passage part 140 at any angle and/or the passage 104 may include a transition (not shown), for example a curved transition (not shown). The dimensions used herein are illustrative and, whilst the arrangement disclosed is advantageous, dimensions should not be considered as being limited by the examples illustrated herein.

Accordingly, other implementations are within the scope of the following claims.

What is claimed is:

1. A valve for a high pressure analytical apparatus, the valve comprising a stator having a stator sealing surface with at least one stator port and a rotor having a rotor sealing surface with at least one channel, the rotor being movable with respect to the stator to selectively move the rotor channel into or out of alignment with the stator port thereby to open or close the valve, wherein the stator port is provided by a passage having a first part that extends perpendicularly from the stator sealing surface and a second part that extends from the first part in a direction which is other than perpendicular from the stator sealing surface.

2. The valve of claim 1, wherein the size or diameter or cross-section of the first passage part is equal to or less than that of the second passage part.

3. The valve of claim 1, wherein the size or diameter or cross-section of the first passage part is 10 to 90 percent that of the second passage part.

4. The valve of claim 3, wherein the size or diameter or cross-section of the first passage part is 40 to 60 percent that of the second passage part.

5. The valve of claim 4, wherein the size or diameter or cross-section of the first passage part is about 50 percent that of the second passage part.

6. The valve of claim 1, wherein the second passage part preferably extends at an angle relative to the first part.

7. The valve of claim 6, wherein the angle is between 1 and 90 degrees.

8. The valve of claim 7, wherein the angle is between 10 and 50 degrees.

9. The valve of claim 8, wherein the angle is between 20 and 40 degrees.

10. The valve of claim 9, wherein the angle is about 30 degrees.

11. The valve of claim 1, wherein the stator comprises a projection which defines the the rotor, the rotor being rotatable relative to the stator to selectively move the channel into or out of alignment with the stator port thereby to open or close the valve.

12. The valve of claim 1, wherein the stator or rotor includes two or more ports or channels or passages.

13. A stator for use in a valve according to any preceding claim, the stator having a stator sealing surface with at least one stator port, wherein the stator port is provided by a passage having a first part that extends perpendicularly from stator sealing surface and a second part that extends from the first part in a different direction thereto.

14. An analytic system comprising a valve according to claim 1

15. The analytic system according to claim 14, wherein the system is a liquid chromatography system
